(19) United States
(12) Patent Application Publication
(10) Pub. No.: US 2012/0156495 A1
(43) Pub. Date: Jun. 21, 2012

(54) METHOD FOR PREPARING SILICA PARTICLES CONTAINING A PHTHALOCYANINE DERIVATIVE, SAID PARTICLES AND USES THEREOF

(75) Inventor: Aurélien Auger, Le Mans (FR)

(73) Assignee: Commisarial a l'energie atomique et aux energies alternatives, Paris (FR)

(21) Appl. No.: 13/392,865

(22) PCT Filed: Aug. 26, 2010
(86) PCT No.: PCT/EP10/62516

§ 371 Date: Mar. 9, 2012

(30) Foreign Application Priority Data
Aug. 27, 2009 (FR) 09 55843

(51) Int. Cl. B32B 5/16; C07F 7/02; B82B 1/00; B82B 3/00

(52) U.S. Cl. 428/402; 540/128; 977/773; 977/840

(57) ABSTRACT

A method for preparing a silica particle incorporating at least one phthalocyanine derivative is provided. In the method, the particle may be prepared from at least one silicon phthalocyanine derivative via an inverse micro-emulsion. In addition, the silica particles and their uses are provided.

### TECHNICAL FIELD

The present invention relates to the field of silica particles and in particular silica nanoparticles containing dyes of the silica phthalocyanine type.

Indeed, the object of the present invention is a method for preparing silica particles incorporating phthalocyanine and naphthalocyanine derivatives. It also relates to silica particles incorporating phthalocyanine and naphthalocyanine derivatives, which may be prepared by this method and to their different uses and applications.

### STATE OF THE PRIOR ART

The synthesis and the properties of dyes derived from complexes of silicon phthalocyanines or naphthalocyanines having axial ligands have been described in the literature by Kenney [1], Joyner [2], and Esposito [3]. Considerable interest has developed over recent years for the physical and chemical properties of phthalocyanines. This interest partly stems from their possible application in various fields such as electrophotography [4], liquid crystals [5], conducting polymers [6], electrochromic display [7], photo-electrochemical conversion of energy [8], infrared-absorbing agents for transparent thermoplastics and cross-linked polymers [9], and photoconductivity [10].

Indeed, phthalocyanines and other macrocyclic analogs have considerably attracted attention as molecular materials with exceptional electronic and optical properties. These properties stem from the delocalization of the electron cloud, and make these products interesting for various fields of research in materials science and most particular in nanotechnology. Thus, phthalocyanines have been successfully incorporated into semiconductor components, components of electrochromic devices, of information storage systems.

A crucial problem to be taken into account in order to incorporate phthalocyanines into technological devices is the control of the spatial arrangement of these macrocycles. This gives the possibility of extending and improving the chemical and physical properties of phthalocyanines at a macromolecular or molecular scale. Co-facial superposition of phthalocyanines is required in order to obtain supramolecular properties. For example, the increase in conductivity may be accomplished along the main axis of the stacking system of the phthalocyanines by delocalization of electrons through coplanar macrocycles. Conductivity in systems based on phthalocyanines generally depends on intrinsic properties of quite particular phthalocyanines. Thus, silicone phthalocyanines were used for preparing devices such as field effect transistors. Good conductivity is also obtained in polymers based on phthalocyanines. Among a large variety of semiconducting polymers based on phthalocyanines, the most important family is that of siloxanes of phthalocyanines [PcSiO₂]ₙ.

Thus, nano-objects and other siloxane phthalocyanine polymers are well known in the prior art. These structures are made in various ways in the literature. Several methods have been validated for polymerization of silica phthalocyanine.

The preparation of phthalocyanine polysiloxanes has been described in the literature. Thus polymers have been synthesized by using silicone phthalocyanines as precursors. These compounds enter the preparation of Langmuir-Blodgett films, one dimensional films of the highly rigid polymer type [11]. Polymerization is carried out in vacuo at 350-400° C. for 2 h, highly extreme conditions. Another synthesis of polymers is conducted with the same silicone phthalocyanine precursor in dimethylsulfoxide at 135° C. for 24 h [12]. More recently, a novel and more appropriate procedure has been reported for preparing oligomers of 3 to 4 units of monomers (silicone phthalocyanine) [13], said procedure comprising the condensation of monomers in the presence of quinoline followed by silylation with tert-butyldimethylsilyl chloride (TBDMSC1).

Another approach was developed in order to obtain a crosslinked polymer axially to the plane of the aromatic macrocycle of the phthalocyanine. Thus, axial functionalization led to obtaining the axially conjugate silicon phthalocyanine with a poly(polysebacic acid anhydride). The thereby obtained product was then used for forming hydrophilic nanoparticles via a microphase inversion method [14].

It should be generally emphasized that these polymers produce high electric conductivities. However, these materials are both insoluble in water and in common organic solvents, which makes their industrial preparation difficult. Indeed, the organic nature of the aromatic macrocycles of the phthalocyanine type makes the latter highly insoluble. The insolubility is more apparent upon using naphthalocyanines or anthracene analogs. This phenomenon is partly due to aggregates formed by π-π interactions. Thus, it is sometimes necessary to substitute the aromatic macrocycle in peripheral and/or non-peripheral positions in order to impart good solubility in organic solvents to this family of dyes. Unfortunately, this functionalization may cause changes in the intrinsic properties. Thus, in certain cases, it is preferable to keep the aromatic network of the non-substituted macrocycle.

Encapsulation of silicon phthalocyanines has also been the subject of a few studies. Taking into account the pronounced and recognized hydrophobicity of materials based on phthalocyanines, it is very difficult to encapsulate them in silica nano-objects by using a conventional method via a wet route.

Thus, a derivative of silicon phthalocyanine bis-oleate was introduced into lipoprotein nanoparticles, in order to use these products as nanoplatforms with a lipoprotein base. These compounds are subsequently used as multi-functional and therapeutic diagnostic devices [15]. A patent application also relates the encapsulation of copper phthalocyanine crystals (no mentioned presence of silicon) [16]. The study of thereby prepared nanoparticles for inks containing dispersions, for color filters and the photosensitive and colored resin composition has also been reported [17].

Finally, a study describes the formation of cadmium selenide (CdSe) nanoparticles conjugate with silicon phthalocyanines. The surface of the CdSe nanoparticles is thereby functionalized by condensation of the active group (amine group), located in an axial position of the macrocycle of silicon phthalocyanine and connected to the latter via an alkyl group [18]. A similar study published in 2006 shows the introduction of copper phthalocyanine tetrasulfonate on the modified surface of silica nanoparticles by functionalization with amine groups [19].

The international application WO 2008/138727 reports the preparation of silica nanoparticles functionalized by copper phthalocyanine. The siloxane function borne by the copper phthalocyanine and required for the formation of silica nanoparticles, is in a peripheral position and requires a step for functionalization of copper phthalocyanine [20].

There exists a real need for a simple, practical method, applicable on an industrial scale for preparing materials based on phthalocyanines such as silica particles.

### DISCUSSION OF THE INVENTION

With the present invention it is possible to find a remedy for the drawbacks and technical problems listed above. Indeed, the latter proposes a method for preparing spherical particulate materials based on silica and notably nanoparticulate materials, the size of which is advantageously less than 100 nm, incorporating phthalocyanine derivatives, said method being applicable on an industrial scale, not requiring any unwieldy methods or steps and using easily accessible, non-dangerous and not very toxic products.

The work of the inventors has shown that by using derivatives of silicon phthalocyanines as silica precursors, it is possible to make silica particles such as silica nanoparticles incorporating phthalocyanine derivatives. The availability of axial ligands combined with the presence of the silicon atom introduced into the cavity of the phthalocyanine macrocycle allows it to be used as a precursor required for proper synthesis of silica nanoparticles via an inverse micellar route.

This work has also given the possibility of surmounting the technical prejudice related to the pronounced hydrophobicity of the materials based on phthalocyanines. Indeed, one skilled in the art would not have used an inverse micellar system for preparing silica particles incorporating phthalocyanine derivatives since the formed micelles contain water which is considered as incompatible with the hydrophobicity of these derivatives.

Further, within the scope of the present invention, the surface of the silica particles obtained with the method according to the invention may be functionalized thereby allowing influence on the polarity of the particles, and thus on the affinity with the solvent to be used in the case of the application, i.e. a polar, apolar solvent, etc., and therefore with the desired dispersion.

Thus, the present invention relates to a method for preparing a silica particle incorporating at least one phthalocyanine derivative, said particle being prepared from at least one silicon derivative of phthalocyanine via an inverse micro-emulsion.

By <<inverse micro-emulsion>>, also called a <<water-in-oil>> micro-emulsion, is meant a thermodynamically stable, limpid suspension of fine droplets of a first polar liquid in a second non-polar liquid and therefore non-miscible with the first liquid. The expression <<via an inverse micellar route>> is equivalent to the expression: <<via an inverse micro-emulsion>>.

By <<silicon derivative of phthalocyanine>>, is meant a compound of formula (I)

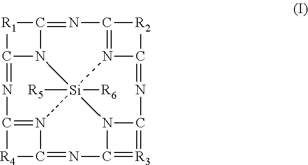

wherein
   R₁, R₂, R₃ and R₄, either identical or different, represent an optionally substituted arylene group and
   R₅ and R₆, either identical or different, are selected from the group consisting of —Cl, —F, —OH and
      —OR′ with R′ representing an optionally substituted linear or branched alkyl with 1 to 12 carbon atoms and notably from 1 to 6 carbon atoms.

By <<optionally substituted>>, is meant within the scope of the alkyl groups of compounds of formula (I), substituted with a halogen, an amine group, a diamine group, an amide group, an acyl group, a vinyl group, a hydroxyl group, an epoxy group, a phosphonate group, a sulfonic acid group, an isocyanate group, a carboxyl group, a thiol (or mercapto) group, a glycidoxy group or an acryloxy group and notably a methacryloxy group. Advantageously, R′ represents a methyl or an ethyl.

By <<arylene group>>, is meant within the scope of the present invention, an aromatic or heteroaromatic carbonaceous structure, optionally mono- or poly-substituted, consisting of one or more aromatic or heteroaromatic rings each including from 3 to 8 atoms, the heteroatom(s) may be N, O, P or S.

By <<optionally substituted>>, is meant an arylene group which may be mono- or poly-substituted with a group selected from the group formed by a carboxylate; an aldehyde; an ester; an ether; a hydroxyl; a halogen; an aryl such as phenyl, benzyl or naphthyl; a linear or branched alkyl with 1 to 12 carbon atoms and notably from 1 to 6 carbon atoms, optionally substituted such as a methyl, an ethyl, a propyl or a hydroxypropyle; an amine, an amide, a sulfonyl; a sulfoxide and a thiol.

Advantageously, the groups R₁, R₂, R₃ and R₄ are either identical or different, each representing a phenylene, a naphthalene or an anthracene. More particularly, the groups R₁, R₂, R₃ and R₄ are identical and represent a phenylene, a naphthalene or an anthracene.

In particular, the silicon derivative of phthalocyanine applied within the scope of the present invention is a compound of formula (II):

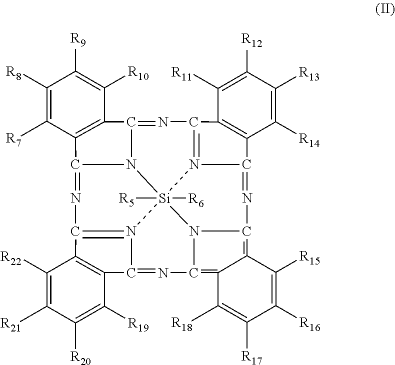

wherein
   the groups R₇ to R₂₂, either identical or different, are selected from the group consisting of a hydrogen; a carboxylate; an aldehyde; a ketone; an ester; an ether; a hydroxyl; a halogen; an aryl such as a phenyl; benzyl or naphthyl; an optionally substituted linear or branched alkyl with 1 to 12 carbon atoms and notably from 1 to 6 carbon atoms, such as a methyl, an ethyl, a propyl, or a hydroxypropyl; an amine; an amide; a sulfonyl; a sulfoxide; and a thiol.
   the groups R₅ and R₆ are as defined earlier.

A preferred compound of formula (II) within the scope of the present invention is the compound wherein the groups R₇ to R₂₂ represent a hydrogen and the groups R₅ and R₆ are as defined earlier.

Alternatively, the silicon derivative of phthalocyanine applied within the scope of the present invention is a compound of formula (III) of the naphthalocyanine type:

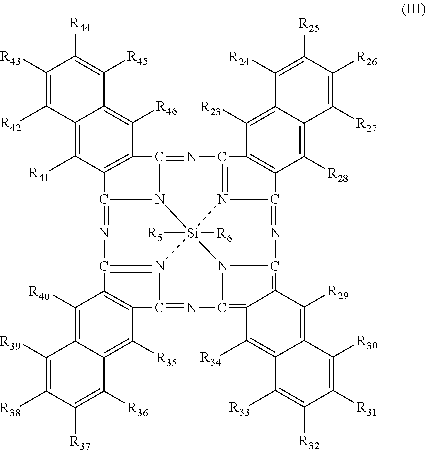

wherein
   the groups R₂₃ to R₄₆, either identical or different, are selected from the group consisting of a hydrogen; a carboxylate; an aldehyde; a ketone; an ester; an ether; a hydroxyl; a halogen; an aryl such as a phenyl, benzyl or naphthyl; a optionally substituted linear or branched alkyl with 1 to 12 carbon atoms and notably from 1 to 6 carbon atoms, such as a methyl, an ethyl, a propyl, or a hydroxylpropyl; an amine; an amide; a sulfonyl; a sulfoxide and a thiol.
   the groups R₅ and R₆ are as defined earlier.

A preferred compound of formula (III) within the scope of the present invention is the compound wherein the groups R₂₃ to R₄₆ represent a hydrogen and the groups R₅ and R₆ are as defined earlier.

In the formulae (I), (II) and (III), the bonds in dotted lines represent coordination bonds or dative bonds.

Advantageously, the groups R₅ and R₆ in the compounds of formula (I), (II) or (III) are identical and are selected from the group consisting of —Cl, —F, —OH and —OR′ with R′ representing an optionally substituted linear or branched alkyl with 1 to 12 carbon atoms and notably from 1 to 6 carbon atoms, and selected from the group consisting of —Cl, —F, —OH, —OCH₃ and —OC₂H₅. More particularly, the groups R₅ and R₆ in the compounds of formulae (I), (II) or (III) are identical and represent —OH or —Cl.

The compounds of formula (II) and (III) most particularly applied within the scope of the present invention are a phthalocyanineatodichlorosilane, a phthalocyanineadihydroxysilane, a naphthlocyanineatodichlorosilane complex and a naphthalocyanineatodihydroxysilane complex. These complexes may be illustrated with R representing —OH or —Cl in the following way:

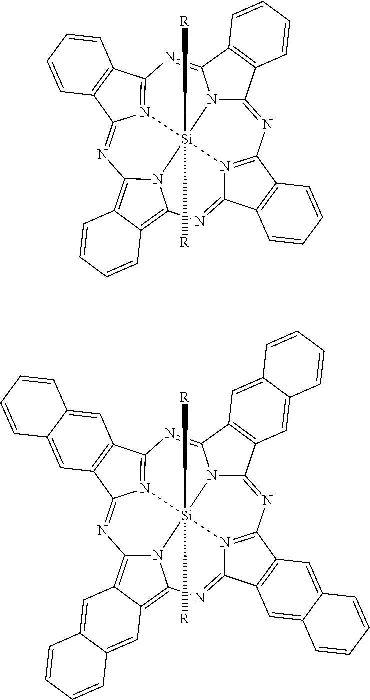

The method according to the invention more particularly comprises the following successive steps:

a) preparing a micro-emulsion (Mₐ) of the water-in-oil type containing at least one silicon phthalocyanine derivative,

b) optionally adding to the micro-emulsion (Mₐ) obtained in step (a), at least one silane compound,

c) adding to the micro-emulsion (M_{b}) obtained in step (b), at least one compound allowing hydrolysis of silane compounds,

d) adding to the micro-emulsion (M_{c}) obtained in step (c) a solvent allowing destabilization of said micro-emulsion,

e) recovering the silica particles incorporating at least one silicone derivative of phthalocyanine, having precipitated during step (d).

The step (a) of the method according to the invention therefore consists of preparing a micro-emulsion (Mₐ) of the water-in-oil type containing at least one silicon phthalocyanine derivative. Any technique allowing preparation of such a micro-emulsion may be used within the scope of the present invention. Thus, it is possible to:
either prepare a first solution (M₁) and subsequently incorporate therein silicon phthalocyanine derivative(s) in order to obtain the micro-emulsion (Mₐ);
or prepare the micro-emulsion (Mₐ) directly by mixing together the different components and therefore silicon phthalocyanine derivative(s).

Advantageously, the step (a) of the method according to the invention consists of preparing a first solution (M₁) in which are subsequently incorporated silicon phthalocyanine derivative(s). This solution (M₁) is obtained by mixing together
at least one surfactant,
optionally at least one co-surfactant and
at least one non-polar or weakly polar solvent.

Advantageously, the surfactant, the optional co-surfactant and the non-polar or weakly polar solvent are added one after the other and in the following order, surfactant and then optionally co-surfactant and then non-polar or weakly polar solvent.

The mixing is carried out with stirring by using a stirrer, a magnetic bar, an ultrasonic bath or a homogenizer and may be applied at a temperature comprised between 10 and 40° C., advantageously between 15 and 30° C. and, more particularly, at room temperature (i.e. 23° C.±5° C.) for a duration comprised between 1 and 45 min, notably between 5 and 30 min, and in particular for 15 min.

The surfactant(s) which may be used within the scope of the present invention aim(s) at introducing hydrophilic species into a hydrophobic environment and may be selected from ionic surfactants, non-ionic surfactants and mixtures thereof. By <<mixtures>>, is meant within the scope of the present invention a mixture of at least two different ionic surfactants, a mixture of at least two different non-ionic surfactants or a mixture of a non-ionic surfactant and of at least one ionic surfactant.

An ionic surfactant may notably appear as a charged hydrocarbon chain, the charge of which is counter-balanced by a counter-ion. As non-limiting examples of ionic surfactants, mention may be made of sodium bis(2-ethylhexyl sulfosuccinate) (AOT), cetyltrimethylammonium bromide (CTAB), cetylpyridinium bromide (CPB) and mixtures thereof.

A non-ionic surfactant which may be used within the scope of the present invention may be selected from the group consisting of polyethoxylated alcohols, polyethoxylated phenols, oleates, laureates and mixtures thereof. As non-limiting examples of commercial non-ionic surfactants, mention may be made of the Triton X surfactants such as Triton X-100; the Brij surfactants such as Brij-30; the Igepal CO surfactants such as Igepal CO-720; the Tween surfactants such as Tween 20; the Span surfactants such as Span 85.

Advantageously, the surfactant used within the scope of the present invention is Triton X-100.

A co-surfactant may optionally be added into the solution (M₁).

By <<co-surfactant>>, is meant within the scope of the present invention an agent capable of facilitating formation of micro-emulsions and of stabilizing them. Advantageously, said co-surfactant is an amphiphilic compound selected from the group consisting of a sodium alkyl sulfate with 8 to 20 carbon atoms such as SDS (Sodium Dodecyl Sulfate); an alcohol such as an isomer of propanol, butanol, pentanol and hexanol; a glycol and mixtures thereof.

Advantageously, the co-surfactant used within the scope of the present invention is n-hexanol.

Any non-polar or weakly polar solvent may be used within the scope of the present invention. Advantageously, said non-polar or weakly polar solvent is a non-polar or weakly polar organic solvent and notably selected from the group consisting of n-butanol, hexanol, cyclopentane, pentane, cyclohexane, n-hexane, cycloheptane, n-heptane, n-octane, iso-octane, hexadecane, petroleum ether, benzene, isobutyl-benzene, toluene, xylene, cumenes, diethyl ether, n-butyl acetate, isopropyl myristate and mixtures thereof.

Advantageously, the non-polar or weakly polar solvent used within the scope of the present invention is cyclohexane.

In the solution (M₁), the surfactant is present in a proportion comprised between 1 and 30%, notably between 5 and 25% and in particular between 10 and 20% by volume, based on the total volume of said solution. The co-surfactant is optionally present, in the solution (M₁), in a proportion comprised between 1 and 30%, notably between 5 and 25% and, in particular between 10 and 20% by volume based on the total volume of said solution. Thus, the non-polar or weakly polar solvent is present in the solution (M₁), in a proportion comprised between 40 and 98%, notably between 50 and 90% and, in particular between 60 and 80% by volume based on the total volume of said solution.

Once the solution (M₁) is prepared, the silicon phthalocyanine derivative(s) as defined earlier is(are) incorporated in order to form the micro-emulsion (Mₐ) of the water-in-oil type.

The silicon phthalocyanine derivative(s) may be added in solid form, in liquid form or as a solution into a polar solvent. When several different silicon phthalocyanine derivatives are used, they may be mixed once or be added one after another or by groups.

Regardless of the applied alternative, a polar solvent is added to the micro-emulsion (Mₐ) after incorporation of said silicon phthalocyanine derivative(s) into the solution (M₁). Advantageously, the silicon phthalocyanine derivative(s) is(are) added to the solution (M₁) as a solution in a polar solvent and then some polar solvent, either identical or different from the first, is further added. Most particularly, both polar solvents used are identical. Alternatively, both used polar solvents are different but at least partly miscible: for example THF and water. The addition of the silicon phthalocyanine derivative and optionally of the polar solvent may be carried out with stirring by using a stirrer, a magnetic bar, an ultrasonic bath or a homogenizer.

By <<polar solvent>>, is meant within the scope of the present invention a solvent selected from the group consisting of water, deionized water, distilled water, either acidified or basic, hydroxylated solvents such as methanol and ethanol, liquid glycols of low molecular weight such as ethylene glycol, dimethylsulfoxide (DMSO), acetonitrile, acetone, tetrahydrofurane (THF) and mixtures thereof.

The polar solvent or the mixture of polar solvents (a polar solvent in which the silicon phthalocyanine derivative(s) is(are) in solution and/or another polar solvent added subsequently) is present in the micro-emulsion (Mₐ), in a proportion comprised between 0.5 and 20%, notably between 1 and 15% and, in particular between 2 and 10% by volume based on the total volume of said micro-emulsion. The silicon phthalocyanine derivative(s) is(are) present in this polar solvent or this mixture of polar solvents in an amount comprised between 0.05 and 10%, notably between 0.1 and 5% and, in particular between 0.2 and 1% by volume based on the total volume of polar solvents.

Step (b) is optional. When it is applied, it consists of incorporating into the thereby obtained micro-emulsion (Mₐ) a silane compound or several silane compounds, either identical or different, which will give just like the silicon phthalocyanine derivative(s) by a sol-gel reaction, the silica of the silica particles of the invention. The incorporation into the micro-emulsion (Mₐ) of the silane compound(s) in order to obtain the micro-emulsion (M_{b}) of the water-in-oil type is carried out by injection, advantageously followed by stirring by using a stirrer, a magnetic bar an ultrasonic bath or a homogenizer, and may be applied at a temperature comprised between 10 and 40° C., advantageously between 15 and 30° C. and, most particularly, at room temperature (i.e. 23° C. ±5° C.) for a period comprised between 5 min and 2 h, notably between 15 min and 1 h and, in particular for 30 min.

Advantageously, said silane compound(s) is(are) an alkysilane or an alkoxysilane. More particularly, said silane compound(s) is(are) of general formula SiRₐR_{b}R_{c}R_{d} wherein Rₐ, R_{b}, R_{c} and R_{d} are independently of each other selected from the group consisting of a hydrogen; a halogen; an amine group; a diamine group; an amide group; an acyl group; a vinyl group; a hydroxyl group; an epoxy group; a phosphonate group; a sulfonic acid group; an isocyanate group; a carboxyl group; a thiol (or mercapto) group; a glycidoxy group; an acryloxy group such as a methacryloxy group; a linear or branched optionally substituted alkyl group with 1 to 12 carbon atoms, notably from 1 to 6 carbon atoms; a linear or branched, optionally substituted, aryl group with 4 to 15 carbon atoms, notably from 4 to 10 carbon atoms; an alkoxyl group of formula —ORₑ with Rₑ representing an alkyl group as defined earlier and salts thereof.

By <<optionally substituted>>, is meant within the scope of alkyl and aryl groups of silane compounds, substituted with a halogen, an amine group, a diamine group, an amide group, an acyl group, a vinyl group, a hydroxyl group, an epoxy group, a phosphonate group, a sulfonic acid group, an isocyanate group; a carboxyl group, a thiol (or mercapto) group, a glycidoxy group or an acryloxy group and notably a methacryloxy group.

The silane compound is more particularly selected from the group consisting of dimethylsilane (DMSi), phenyltriethoxysilane (PTES), tetraethoxysilane (TEOS), n-octyltriethoxysilane, n-octadecyltriethoxysilane, dimethyldimethoxysilane (DMDMOS), (3-mercaptopropyl)trimethoxysilane, (3-mercaptopropyl) triethoxysilane, (mercapto)-triethoxysilane, (3-aminopropyl)triethoxysilane, 3-(2-aminoethylamino)propyltrimethoxysilane, 3-[bis(2-hydroxyethyl)amino]-propyltriethoxysilane, hexadecyltrimethoxysilane, phenyltrimethoxysilane, N-3-(trimethoxysilyl)propyl]-1,2-ethanediamine and acetoxyethyltriethoxysilane, 2-hydroxy-4-(3-triethoxysilylpropoxy)diphenylketone, methyl-triethoxysilane, vinyltrimethoxysilane, (3-glycidoxypropyl)trimethoxysilane, (benzoyloxypropyl)trimethoxysilane, sodium 3-trihydroxysilylpropylmethylphosphonate, (3-trihydroxysilyl)-1-propanesulphonic acid, (diethylphosphonatoethyl)triethoxysilane, and mixtures thereof. More particularly, the silane compound is tetraethoxysilane (TEOS, Si (OC₂H₅)₄).

With view to the functionalization of the surface of the silica particles obtained according to the invention, the applied silane compound may be a mixture containing less than 20% and notably from 5 to 15% of a prefunctionalized silane based on the total amount of silane compounds. As an example, a mixture containing TEOS and from 5 to 15% of mercaptotriethoxysilane may be used for preparing silica particles according to the invention and functionalized by thiol groups.

In the micro-emulsion (M_{b}), the silane compound(s) is(are) present in a proportion comprised between 0.05 and 20%, notably between 0.1 and 10% and, in particular between 0.5 and 5% by volume based on the total volume of said micro-emulsion.

The step (c) of the method according to the invention aims at providing hydrolysis of a silane compound by adding to the micro-emulsion (M_{b}) a compound allowing this hydrolysis, the thereby obtained micro-emulsion (M_{c}) being a water-in-oil micro-emulsion. It should be noted that by <<a compound allowing hydrolysis of silane compounds>>, is meant a compound allowing not only hydrolysis of a silane compound but also the hydrolysis of a silicon phthalocyanine derivative.

The compound allowing hydrolysis of the silane compound is advantageously selected from the group consisting of ammonia, sodium hydroxide (KOH), lithium hydroxide (LiOH) and sodium hydroxide (NaOH) and, advantageously a solution of such a compound in a polar solvent, either identical with or different from the polar solvent implemented during step (b). The compound allowing hydrolysis of the silane compound is more particularly ammonia or a solution of ammonia in a polar solvent as defined earlier. Indeed, ammonia acts as a reagent (H₂O) and as a catalyst (NH₄OH) for the hydrolysis of the silane compounds or of the silicon phthalocyanine derivative.

The compound allowing hydrolysis of the silane compound, when it is in solution in the polar solvent, is present in a proportion comprised between 5 and 50%, notably between 10 and 40% and, in particular between 20 and 30% by volume based on the total volume of said solution. Further, said solution is present in a proportion comprised between 0.05 and 20%, notably between 0.1 and 10% and, in particular between 0.5 and 5% by volume based on the total volume of the micro-emulsion (M_{c}).

Step (c) may be implemented with stirring by using a stirrer, a magnetic bar, an ultrasonic bath or a homogenizer, and at a temperature comprised between 10 and 40° C., advantageously between 15 and 30° C. and more particularly at room temperature (i.e. 23° C. ±5° C.) for a period comprised between 6 and 48 h, notably between 12 and 36 h and in particular for 24 h.

When the silane compound used is TEOS, the reaction which occurs during step (c) of the method i.e. the condensation of the silicon phthalocyanine derivative with TEOS in the presence of ammonia may be schematized in the following way:

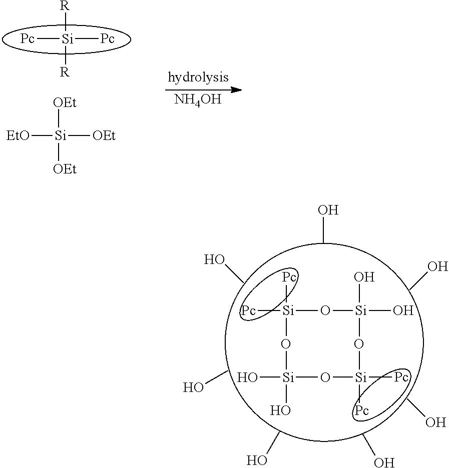

Step (d) of the method according to the invention aims at precipitating the silica particles by adding a solvent which does not denaturate the structure of the particles but which destabilizes or denaturates the micro-emulsion (M_{c}) obtained in step (c).

Advantageously, the implemented solvent is a polar solvent as defined earlier. A particular solvent to be applied during step (d) is selected from the group consisting of ethanol, acetone and methanol. Advantageously the solvent used during step (d) of the method according to the invention is ethanol. Thus, to the micro-emulsion (M_{c}) is added a volume of solvent greater than the volume of said micro-emulsion, notably greater by a factor 1.5; in particular greater by a factor 2; or even greater by a factor 3.

Any technique allowing recovery of the silica particles incorporating at least one phthalocyanine derivative, precipitated during step (d) may be applied during step (e) of the method according to the invention. Advantageously, this step (e) implements one or several steps, either identical or different, selected from the steps of centrifugation, sedimentation and washings. The washing step(s) is(are) carried out in a polar solvent as defined earlier. When the recovery step applies several washings, a same polar solvent is used for several or even for all the washings or several different polar solvents are used at each washing. As regards centrifugation step(s), it(they) may be applied by centrifuging the silica particles notably in a washing solvent at room temperature, at a speed comprised between 4,000 and 8,000 rpm and, in particular of the order of 6,000 rpm (i.e. 6,000±500 rpm) and this for a period comprised between 5 min and 2 h, notably between 10 min and 1 h and in particular for 15 min.

The method according to the present invention may comprise, following step (e), an additional step consisting of purifying the silica particles obtained hereafter, designated as <<step (f)>>.

Advantageously, this step (f) consists of putting the silica particles recovered after step (e) of the method according to the invention into contact with a very large volume of water. By <<very large volume>> is meant a volume greater by a factor of 50, notably by a factor of 500 and in particular by a factor of 1,000 than the volume of silica particles, recovered after step (e) of the method according to the invention. Step (f) may be a dialysis step, the silica particles being separated from the volume by a cellulose membrane, of the Zellu trans® (Roth) type. Alternatively, provision may be made for an ultrafiltration step instead of the dialysis step, via a polyethersulfone membrane. The step (f) may further be applied with stirring by using a stirrer, a magnetic bar, an ultra-sonic bath or a homogenizer at a temperature comprised between 0 and 30° C., advantageously between 2 and 20° C. and, more particularly under cold conditions (i.e. 6° C.±2° C.) and this for a period comprised between 30 h and 15 days, notably between 3 days and 10 days and in particular for 1 week.

The present invention also relates to the micro-emulsion (M_{c}) which may be applied within the scope according to the method of the invention. This micro-emulsion of the water-in-oil type comprises:
at least one surfactant, notably as defined earlier,
optionally at least one co-surfactant, notably as defined earlier,
at least one non-polar or weakly polar solvent, notably as defined earlier,
at least one polar solvent, notably as defined earlier,
at least one silicon phthalocyanine derivative notably as defined earlier,
optionally at least one silane compound, notably as defined earlier, and
at least one compound capable of hydrolyzing a silane compound, notably as defined earlier.

Advantageously, the micro-emulsion of the water-in-oil type, object of the present invention, comprises:
at least one surfactant in an amount comprised between 1 and 30%, notably between 5 and 25% and in particular between 10 and 20%;
optionally at least one co-surfactant in an amount comprised between 1 and 30%, notably between 5 and 25% and in particular between 10 and 20%;
at least one non-polar or weakly polar solvent in an amount comprised between 40 and 95%, notably between 50 and 90% and in particular between 60 and 80%;
at least one polar solvent in an amount comprised between 0.5 and 20%, notably between 1 and 15% and in particular between 2 and 10%;
at least one silicon phthalocyanine derivative in an amount comprised between 0.001 and 1%, notably between 0.005 and 0.1% and in particular between 0.001 and 0.05%;
optionally at least one silane compound in an amount comprised between 0.05 and 20%, notably between 0.1 and 10% and in particular between 0.5 and 5%; and
at least one compound capable of hydrolyzing said silane compound in an amount comprised between 0.01 and 5%, notably between 0.05 and 1% and, in particular between 0.1 and 0.5%,

the amount being expressed by volume based on the volume of said micro-emulsion.

The present invention further relates to a silica particle which may be prepared by the method of the present invention. This particle is a silica particle comprising at least one phthalocyanine derivative, as defined earlier. It is distinguished from silica particles of the state of the art because of the two covalent bonds which bind the Si atom to the phthalocyanine derivative, the phthalocyanine derivative not being a group which functionalizes the silica particle. Indeed, the covalent bonds which bind the Si atom with the phthalocyanine derivative are preserved in the silica particle formed at the end of the method according to the invention. Thus, there exists a strong interaction between the lattice structure of the silica particle and the phthalocyanine derivative(s) by the presence of covalent bonds. Therefore, the phthalocyanine derivative is covalently bound to the silica lattice of the particle according to the invention.

Advantageously, the silica particles according to the invention are nanoparticles having an average size less than or equal to 100 nm, notably comprised between 10 and 80 nm, in particular comprised between 20 and 60 nm, and, even of the order of 40 nm (i.e. 40±10 nm). The silica particles according to the invention may optionally be functionalized. Further the silica particles according to the invention may possibly be porous.

The present invention finally relates to the use of a silica particle according to the invention in fields selected from the group consisting of catalyses, printing, paints, filtration, polymerization, heat exchange, heat stability, materials chemistry, hydrocarbon refining, hydrogen production, absorbance, food industry, transport of active agents, biomolecules, pharmaceutical products, heat-insulated coatings, bioelectric compounds and electronic, optical devices, devices of semiconductors and sensors.

Other characteristics and advantages of the present invention will further become apparent to one skilled in the art upon reading the examples below given as an illustration and not as a limitation and referring to the appended figures.

### SHORT DESCRIPTION OF THE DRAWINGS

FIG. 1 shows a view obtained by transmission electron microscopy (TEM) of agglomerates with silica nanoparticles prepared by the method according to the invention.

FIG. 2 shows a view obtained by transmission electron microscopy (TEM) of silica nanoparticles prepared by the method according to the invention without any agglomerate.

### DETAILED DISCUSSION OF PARTICULAR EMBODIMENTS

### I. A Method for Preparing Silica Nanoparticles According to the Invention

A solution (solution M₁ according to the invention) was generated by adding in this order, the following chemicals, the surfactant Triton X100 (2.1 mL), the co-surfactant n-hexanol (2.05 mL), the cyclohexane organic solvent (9.38 mL). The solution is then stirred at room temperature for 15 min.

Next, the phthalocyanine derivative of silica which is 2,3-naphthalocyanine-silane dihydroxide or <<silicon 2,3-naphthalocyanine dihydroxide>> in a solution of THF was added (100 μL at 0.1 M in THF, M=774.88 g.mol⁻¹, n=10⁻⁵ mol) followed by water (0.5 mL).

The TEOS (tetraethoxysilane, 125 μL, 5.6×10⁻⁴ mol, d=0.934, M=208.33 gmol⁻¹) silicon derivative was injected into this emulsion. The resulting emulsion was stirred at room temperature for 30 min. Hydrolysis of the TEOS was initiated by adding 25% aqueous ammonia (125 μL) and the reaction mixture was stirred for 24 h at room temperature.

The emulsion was destabilized by adding ethanol (50 mL) and the silica beads were washed three times with ethanol and once with water, each washing being followed by sedimentation in the centrifuge (15 min at 6,000 rpm).

After the washing step, the purification of the obtained nanoparticles was completed by dialysis in water (1 L) with magnetic stirring for one week.

### II. Characterization of the Silica Nanoparticles According to the Invention

The silica nanoparticles dispersed in water (40 mL) prepared according to the method of part I were then characterized by transmission electron microscope (TEM) analysis which allows the nanostructure of these nanoparticles to be appreciated.

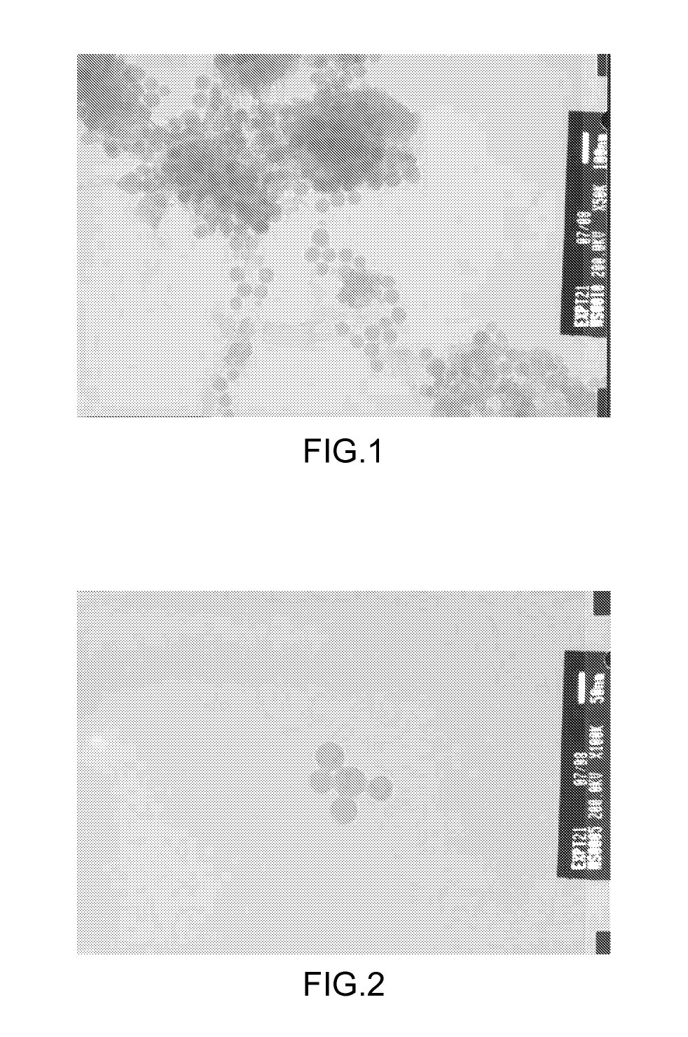

Thus, agglomerates are observed with spherical nanoparticles (FIG. 1). The size of these nanoparticles varies between 40 and 50 nm. FIG. 2 shows spherical nanoparticles without any agglomerates.

### REFERENCES

[1] U.S. Pat. No. 3,094,536 (Kenney) published on Jun. 18^{th} 1963;
[2] Joyner, R. D.; Cekada, J.; Link Jr. R. G.; Kenney, M. E. J. Inorg. Nucl. Chem. 1960, 15, 387;
[3] Esposito, J. N.; Lloyd, J. E.; Keeney, M. E. Inorg. Chem. 1966, 5, 1979;
[4] Lotfy, R. O.; Hor, A. M.; Rucklidge, A. J. Imag. Sci. 1987, 31, 31;
[5] Belarbi, Z.; Sirlin, C.; Simon, J.; Andre, J. J. Phys. Chem. 1989, 93, 8105;
[6] Hanack, M. Mol. Cryst. Liq. Cryst. 1988, 160, 133;
[7] Castenada, F.; Plichon, V.; Clarisse, C.; Riou, M. T. J. Electroanal. Chem. 1987, 233, 77;
[8] Sims, T. D.; Pemberton, J. E.; Lee, P.; Armstrong, N. R. Chem. Mater. 1989, 1, 26;
[9] International application WO 2008/083918 (CIBA HOLDING Inc. and CIBA SPA) published on Jul. 17^{th} 2008;
[10] Hayashida, S.; Hayashi, N. Chem. Mater 1991, 3, 92;
[11] Chen, P.; Tang, D.; Wang, X.; Chen, H.; Liu, M.; Li, J.; Liu, X. Colloids and Surfaces A: Physicochemical and Engineering Aspects 2000, 175, 171;
[12] Nicolau, M.; Henry, C.; Martinez-Diaz, M. V.; Torres, T.; Armand, F.; Palacin, S.; Ruaudel-Teixier, A.; Wegner, G. Synthetic Metals 1999, 102, 1521;
[13] Cammidge, A. N.; Nekelson, F.; Helliwell, M.; Heeney, M. J.; Cook, M. J. J. Am. Chem. Soc. 2005, 127, 16382;
[14] Lee, P. P. S.; Ngai, T.; Wu, C.; Ng, D. K. P. Journal of Polymer Science: Part A: Polymer Chemistry 2005, 43, 837;
[15] Zheng, G.; Chen, J.; Li, H.; Glickson, J. D. PNAS, 2005, 102, 17757;
[16] Patent application JP2005-272760 (TOYO INK MFG CO) published on Oct. 6^{th} 2005;
[17] Inomata H.; Arai K.; Nakanishi H. Jpn. J. Appl. Phys., 1999, 38, L81;
[18] Dayal, S.; Krolicki, R.; Lou, Y.; Qiu, X.; Berlin, J. C.; Kenney, M. E.; Burda, C. Appl. Phys. B 2006, 84, 309;
[19] Kim, T. H.; Lee, J. K.; Park, W. H.; Lee, T. S. Mol. Cryst. Liq. Cryst. 2006, 444, 23;
[20] International application WO 2008/138727 (CIBA HOLDING Inc.) published on Nov. 20^{th} 2008.

1. A method for preparing a silica particle incorporating at least one phthalocyanine derivative, comprising a step of preparing said particle from at least one silicon phthalocyanine derivative via an inverse micro-emulsion.

2. The method according to claim 1, wherein said silicon phthalocyanine derivative is a compound of formula (I) 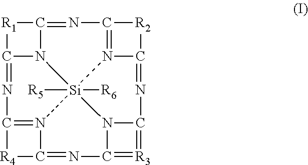
wherein
R₁, R₂, R₃ and R₄, either identical or different, represent an optionally substituted arylene group and
R₅ and R₆, either identical or different are selected from the group consisting of —Cl, —F, —OH and —OR′ with R′ representing an optionally substituted, linear or branched alkyl with 1 to 12 carbon atoms.

3. The method according to claim 1 wherein said silicon phthalocyanine derivative is a compound of formula (II): 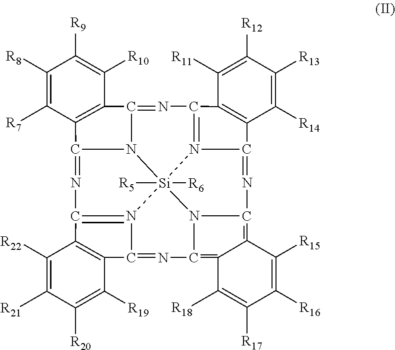
wherein
the groups R₇ to R₂₂, either identical or different, are selected from the group consisting of a hydrogen; a carboxylate; an aldehyde; an ester; an ether; a hydroxyl; a halogen; an aryl such as phenyl, benzyl or naphthyl; an optionally substituted, linear or branched alkyl with 1 to 12 carbon atoms and notably from 1 to 6 carbon atoms, such as a methyl, an ethyl, a propyl or a hydroxypropyl, an amine; an amide; a sulfonyl; a sulfoxide and a thiol;
the groups R₅ and R₆, either identical or different are selected from the group consisting of —Cl, —F, —OH and —OR′ with R′ representing an optionally substituted, linear or branched alkyl with 1 to 12 carbon atoms.

4. The method according to claim 1 wherein said silicon phthalocyanine derivative is a compound of formula (III) of the naphthalocyanine type 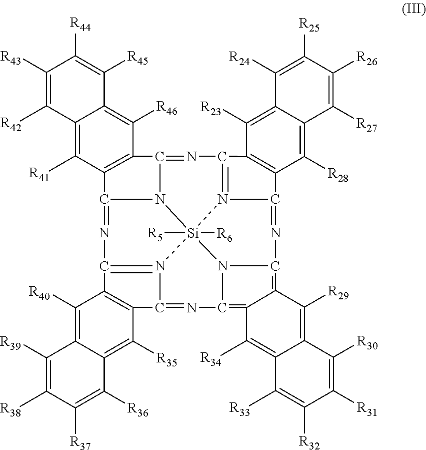
wherein
the groups R₂₃ to R₄₆, either identical or different are selected from the group consisting of a hydrogen; a carboxylate; an aldehyde; an ester; an ether; a hydroxyl; a halogen; an aryl such as phenyl, benzyl of naphthyl; an optionally substituted, linear or branched alkyl with 1 to 12 carbon atoms and notably from 1 to 6 carbon atoms, such as a methyl, an ethyl, a propyl or a hydroxypropyl; an amine; an amide; a sulfonyl; a sulfoxide and a thiol;
the groups R₅ and R₆, either identical or different are selected from the group consisting of —Cl, —F, —OH and —OR′ with R′ representing an optionally substituted, linear or branched alkyl with 1 to 12 carbon atoms.

5. The method according to claim 1, wherein said method comprises the following successive steps:
a) preparing a micro-emulsion (Mₐ) of the water-in-oil type containing at least one silicon phthalocyanine derivative,
b) optionally adding to the micro-emulsion (Mₐ) obtained in step (a), at least one silane compound,
c) adding to the micro-emulsion (M_{b}) obtained in step (b), at least one compound allowing hydrolysis of silane compounds,
d) adding to the micro-emulsion (M_{c}) obtained in step (c) a solvent allowing destabilization of said micro-emulsion,
e) recovering the silica particles incorporating at least one silicon phthalocyanine derivative, having precipitated during step (d).

6. The method according to claim 5, wherein said step (a) consists of preparing a first solution (MO into which are(is) subsequently incorporated silicon phthalocyanine derivative(s).

7. The method according to claim 5, wherein said micro-emulsion (M₁) of the type water-in-oil is obtained by mixing together
at least one surfactant,
optionally at least one co-surfactant and
at least one non-polar or weakly polar solvent.

8. The method according to claim 5, wherein a polar solvent is added to the micro-emulsion (Mₐ) after incorporation of said silicon phthalocyanine derivative(s) in the solution (M₁).

9. The method according to claim 5, wherein said silane compound(s) is(are) of general formula:
SiRₐR_{b}R_{c}R_{d}
wherein Rₐ, R_{b}, R_{c} and R_{d} are independently of each other selected from the group consisting of a hydrogen; a halogen; an amine group; a diamine group; an amide group; an acyl group; a vinyl group; a hydroxyl group; an epoxy group; a phosphonate group; a sulfonic acid group; an isocyanate group; a carboxyl group; a thiol (or mercapto) group; a glycidoxy group; an acryloxy group such as a methacryloxy group; an optionally substituted, linear or branched alkyl group with 1 to 12 carbon atoms, notably from 1 to 6 carbon atoms, an optionally substituted, linear or branched aryl group with 4 to 15 carbon atoms notably from 4 to 10 carbon atoms; an alkoxyl group of formula —OR_{c} with R_{c} representing an alkyl group as defined earlier and salts thereof.

10. The method according to claim 5, characterized in thatwherein said silane compound(s) is(are) selected from the group consisting of dimethysilane (DMSi), phenyltriethoxysilane (PTES), tetraethoxysilane (TEOS), n-octyltriethoxysilane, n-octadecyltriethoxysilane, dimethyldimethoxysilane (DMDMOS), (3-mercaptopropyl)trimethoxysilane, (3-mercaptopropyl)triethoxysilane, (mercapto)-triethoxy-silane, (3-aminopropyl)-triethoxysilane, 3-(2-aminoethyl-amino)propyltrimethoxysilane, 3-[bis(2-hydroxyethyl)amino]propyltriethoxysilane, hexadecyltrimethoxysilane, phenyltrimethoxysilane, N-[3-(trimethoxysilyl)propyl]-1,2-ethanediamine and acetoxyethyltriethoxysilane, 2-hydroxy-4-(3-triethoxysilylpropoxy)diphenylketone, methyl-tri-ethoxysilane, vinyltrimethoxysilane, (3-glycidoxypropyl)trimethoxysilane, (benzoyloxypropyl)-trimethoxy-silane, sodium 3-trihydroxysilylpropylmethyl phosphonate, (3-trihydroxysilyl)-1-propanesulfonic acid, (diethyl-phosphonatoethyl)triethoxysilane, and mixtures thereof.

11. The method according to claim 5, wherein said compound allowing hydrolysis of the silane compound is selected from the group consisting of ammonia, sodium hydroxide (KOH), lithium hydroxide (LiOH) and sodium hydroxide (NaOH).

12. A micro-emulsion (M_{c}) of the water-in-oil type which may be applied within the scope of a method as defined in claim 1, comprising:
at least one surfactant,
optionally at least one co-surfactant,
at least one non-polar or weakly polar solvent,
at least one polar solvent,
at least one silicon phthalocyanine derivative,
optionally at least one silane compound, and
at least one compound capable of hydrolyzing a silane compound.

13. The micro-emulsion according to claim 12, wherein it comprises:
at least one surfactant in an amount comprised between 1 and 30%, notably between 5 and 25% and in particular between 10 and 20%;
optionally at least one co-surfactant in an amount comprised between 1 and 30%, notably between 5 and 25% and in particular between 10 and 20%;
at least one non-polar or weekly polar solvent in an amount comprised between 40 and 95%, notably between 50 and 90% and in particular between 60 and 80%;
at least one polar solvent in an amount comprised between 0.5 and 20%, notably between 1 and 15% and in particular between 2 and 10%;
at least one silicon phthalocyanine derivative in an amount comprised between 0.001 and 1%, notably between 0.005 and 0.1% and in particular between 0.001 and 0.05%;
optionally at least one silane compound in an amount comprised between 0.05 and 20%, notably between 0.1 and 10% and in particular between 0.5 and 5%; and
at least one compound capable of hydrolyzing said silane compound in an amount comprised between 0.01 and 5%, notably between 0.05 and 1% and in particular between 0.1 and 0.5%,
the amounts are expressed by volume based on the volume of said micro-emulsion.

14. A silica particle comprising at least one phthalocyanine derivative, which may be prepared by a method as defined in any of claim 1, said phthalocyanine derivative being covalently bound to the silica lattice of said particle.

15. The silica particle according to claim 14, wherein it has an average size of less than or equal to 100 nm, notably comprised between 10 and 80 nm, in particular comprised between 20 and 60 nm and even of the order of 40 nm.

16. The method according to claim 2, wherein said linear or branched alkyl comprises 1-6 carbon atoms.

17. The method according to claim 3, wherein said linear or branched alkyl comprises 1-6 carbon atoms.

18. The method according to claim 4, wherein said linear or branched alkyl comprises 1-6 carbon atoms.
